(19) United States
(12) Patent Application Publication
(10) Pub. No.: US 2003/0009941 A1
(43) Pub. Date: Jan. 16, 2003

(54) Fountain structure

(76) Inventor: Keith Gunn, House Springs, MO (US)

Correspondence Address: POLSTER, LIEDER, WOODRUFF & LUCCHESI, 763 SOUTH NEW BALLAS ROAD, ST. LOUIS, MO, 63141-8750, US

(21) Appl. No.: 09/904,487

(22) Filed: Jul. 13, 2001

(51) Int. Cl. A01G 25/00

(52) U.S. Cl. 47/82

(57) ABSTRACT

A fountain comprises a planter having a hollow interior for storing a quantity of water, a pump for pumping the quantity of water within the planter, a water discharge device connected to the pump for discharging the quantity of water, and a second planter positioned on an exterior surface of the planter, the second planter receiving a portion of the quantity of water being discharged from the water discharge device.

### CROSS REFERENCE TO RELATED APPLICATIONS

None.

### STATEMENT REGARDING FEDERALLY SPONSORED RESEARCH OR DEVELOPMENT

None.

### BACKGROUND OF THE INVENTION

This invention relates to a fountain construction, and in particular, relates to a fountain which includes a planter for adding an aesthetic feature to the fountain construction.

Planters constructed of lightweight, high grade plastic material of various colors, shapes, and sizes are readily available. The plastic material is extremely rugged, durable, and inexpensive. Because of these features, these planters have become popular for various purposes. Such planters are used for potting plants and flowers for decorating and enhancing the enjoyment of both homes and offices. These planters, because of their durability, also function as landscaping elements for the exterior of homes and offices. Fountains also are popular landscaping items. Fountains, however, generally are expensive to manufacture and maintain. Therefore, a need exists to provide a low cost fountain structure which may be utilized in a variety of situations.

The present invention is designed to obviate and overcome many of the disadvantages and shortcomings associated with the use of present fountains. In particular, the present invention is a fountain which utilizes planters for its basic structure, that basic structure being modified with associated planter parts to provide an aesthetically pleasing design. Moreover, the fountain of the present invention can be employed to construct fountains in a variety of landscaping situations.

### SUMMARY OF THE INVENTION

In one form of the present invention, a fountain comprises a first planter having a hollow interior for storing a quantity of water, a pump for pumping the quantity of water within the fountain, a water discharge device connected to the pump for discharging the quantity of water, and at least a second planter positioned on an exterior surface of the planter, the second planter being arranged to disguise the mature of the first planter.

In another form of the present invention, a fountain comprises a first planter having a hollow interior for storing a quantity of water, a pump for pumping the quantity of water within the planter, a water discharge device connected to the pump for discharging the quantity of water, and a third planter positioned along the base.

In yet another form of the present invention, a fountain comprises a first planter having an upper rim and an interior for storing a quantity of water, a pump for pumping the quantity of water within the planter, a water discharge device connected to the pump for discharging the quantity of water, and at least one additional planter, the second planter for holding flowers or plants and for receiving a portion of the quantity of water being discharged from the water discharge device to water the flowers or plants.

In light of the foregoing comments, it will be recognized that a principal object of the present invention is to provide an improved container for the display of flowers with the additional benefit of a fountain in association therewith.

Another object of the present invention is to provide a fountain which is of simple construction and design and which can be easily employed with highly reliable results.

A further object of the present invention is to provide a fountain that is durable and lightweight which makes the fountain suitable for positioning in various locations.

A still further object of the present invention is to provide a fountain which can be constructed using commercially available components and which does not require any major modifications to accommodate the fountain.

Another object of the present invention is to provide a fountain which is capable of watering or irrigating plants or flowers which are in close proximity to the fountain.

These and other objects and advantages of the present invention will become apparent after considering the following detailed specification in conjunction with the accompanying drawings, wherein:

### BRIEF DESCRIPTION OF THE SEVERAL VIEWS OF THE DRAWINGS

The objects of the invention are achieved as set forth in the illustrative embodiments shown in the drawings which form a part of the specification.

FIG. 1 is a perspective view of a preferred embodiment of a fountain constructed according to the present invention;

FIG. 2 is a cross-sectional view of the fountain for a planter shown in FIG. 1;

FIG. 3 is a perspective view of another preferred embodiment of a fountain constructed according to the present invention;

FIG. 4 is a perspective view of yet another preferred embodiment of a fountain constructed according to the present invention; and

FIG. 5 is a rear inside elevation of a fifth illustrative embodiment of fountains of this present invention.

### DETAILED DESCRIPTION OF THE PREFERRED EMBODIMENTS

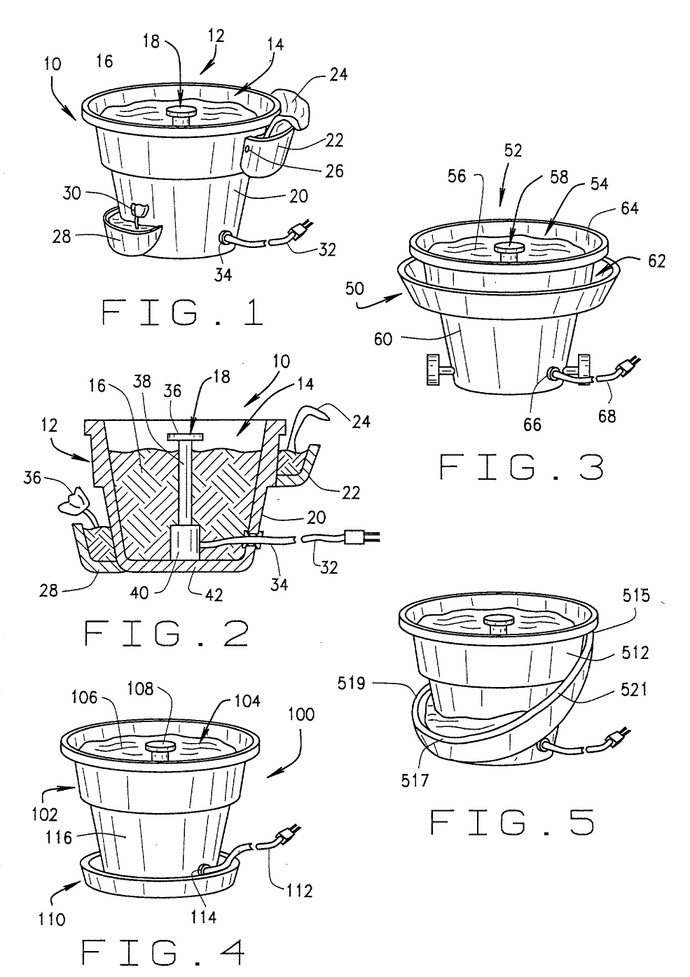

Referring now to the drawings, wherein like numbers refer to like items, number 10 identifies a preferred embodiment of a fountain 10 constructed according to the present invention. With reference now to FIG. 1, the fountain 10 comprises a planter 12 having a hollow interior 14 which may be filled with a quantity of water 16. In this manner, the interior 14 is a reservoir or a container for the water 16. Within the interior 14 of the planter 12 is a water discharge device 18. The water discharge device 18 is capable of spraying water 16 out of the device 18 in such a manner that the water 16 stays within the interior 14 or the water 16 is sprayed outside of the planter 12. Based upon which type of water discharge device 18 is used, various sprays or fountain patterns may be achieved.

The planter 12 has an exterior surface or side 20 upon which may be attached or mounted a second planter 22. The planter 22 is used for potting plants or flowers 24 therein. The planter 22 may be attached or mounted to the exterior surface 20 by using any suitable means, such as by bolts 26, screws, rivets, or adhesives. Additionally, the planter 22 may be removable from the planter 12. A third planter 28 is also shown to be attached or mounted to the exterior surface 20 of the planter 12. The third planter 28 is attached to the planter 12 by using any suitable attachment means as has been described with reference to the planter 22. The third planter 28 may also be used for storing or potting plants or flowers 30. The second planter 22 is positioned along the exterior surface 20 at a location which is different from the third planter 28. For example, the second planter 22 is semi-circular in shape and takes up less than half of the circumference of the planter 12. The second planter 22 is also positioned at a higher location that that of the third planter 28. The third planter 28 may also be semi-circular in shape and is shown taking up less than half of the circumference of the planter 12. However, it is possible that the planters 22 and 28 may each take up half of the circumference of the planter 12. The planters 22 and 28 are offset from each other and this allows the plants 24 and 30 to provide a highly decorative and pleasing appearance at relatively low cost. In addition with this arrangement, any water 16 which is sprayed outside of the planter 12 will be used to water or irrigate the plants 24 and 30 within the planters 22 and 28, respectively.

The exterior surface 20 of the planter 12 also has an electrical cord 32 extending out of a watertight opening 34 in the surface 20. The cord 32 is connected to a pump (not shown), as will be explained. The cord 32 may be connected to a power source in order to provide electricity to the pump. The opening 34 has been made in the planter 12 to facilitate placement of the cord 32 through the planter 12. Although the opening 34 is shown, it is also possible and contemplated to use a drainage hole that may already be provided in the planter 12.

Referring now to FIG. 2, a cross-sectional view fountain for a planter 10 as shown in FIG. 1 is illustrated. The fountain for a planter 10 is shown to comprise the planter 12 having the hollow interior 14 which is filled with water 16. The water 16 fills most of the interior 14 of the planter 12. The water discharge device 18 comprises a fountain or sprinkler head portion 36 which is connected to a tubular post member 38. The member 38 is further connected to a fluid or water pump 40 which is capable of taking water 16 from the interior 14 and pumping the water 16 through the member 38 and out of the head portion 36. In this manner, the pump 40, the member 38, and the head portion 36 form a fountain within the planter 12. Also connected to the pump 40 is the cord 32 which has been inserted through the opening 34.

The planter 12 includes a bottom portion or floor 42 on which is mounted or attached the pump 40. The pump 40 may be positioned centrally or off center. Although the pump 40 is shown to be in the planter 12, it should be recognized that the pump 40 may be placed outside of the planter 12. Further, it is possible to include more than one pump 40 or more than one head portion 36 to provide for numerous streams of water 16 being in the planter 12. For example, one of the head portions 36 may be a sprinkler type device and another head portion 36 may be a spray type device. This would provide for different fountain effects in the planter 12.

The second planter 22 is further shown to be positioned on the exterior surface 20 of the planter 12. The third planter 28 is also shown to be positioned at a different location on the exterior surface 20 of the planter 12. Again, in this orientation, water 16 which is sprayed outside of the planter 12 may be used to water the plants 24 and 30 which are within the planters 22 and 28, if desired. In addition, at least the planter 22 may be in fluid communication with the interior of the planter 12, so that excess water sprayed outside of the planter 22 is returned to the interior 14 of the planter 12.

As can be appreciated, the fountain for a planter 10 may be initially placed at any desired location. The planters 22 and 28 are then filled with soil and the flowers or plants 24 and 30 may be placed in their respective planters 22 and 28. The interior 14 of the planter 12 may then be filled with water 16 and once the water 16 reaches a desired level within the planter 12, the pump 40 may be turned on. If required, the head portion 36 may be adjusted to direct the water 16 in any suitable or desired direction. Due to evaporation, the water 16 within the planter 12 may have to be replenished. Further, if the fountain for a planter 10 needs to be moved, then the water 16 may have to be emptied prior to moving in order to reduce the weight of the fountain for a planter 10.

With reference now to FIG. 3, another embodiment of a fountain for a planter 50 is depicted. The fountain for a planter 50 comprises a planter 52 having a hollow interior 54 which may be filled with a quantity of water 56. In this manner, the interior 54 serves as a reservoir or a container for the water 56. The interior 54 of the planter 52 also has a water discharge device 58 for spraying water 56 out of the device 58 in order to function as a fountain within the planter 52. The planter 52 has an exterior surface 60 upon which may be attached or mounted a second planter 62. The planter 62 encircles an upper rim 64 of the planter 52 and placed therein may be flowers or plants along with soil. The exterior surface 60 further has an opening 66 through which is inserted an electrical cord 68. As has been previously described, the cord 68 is connected to a water pump which is used to recirculate or pump the water 56 through the water discharge device 58. As can be appreciated, the planter 62 may receive water 56 from the water discharge device 58, if desired.

FIG. 4 illustrates another preferred embodiment of a fountain for a planter 100 which is constructed according to the present invention. In particular, the fountain for a planter 100 comprises a planter 102 having a hollow interior 104 which may be filled with a quantity of water 106. The interior 104 of the planter 102 also has a water discharge device 108 for spraying water 106 out of the device 108 in a fountain like manner. The planter 102 rests upon a base or tray 110. The base 110 may be wider than the planter 102 and may also include flowers or plants (not shown). Again, the water 106 may be sprayed outside of the planter 102, if desired, to water the flowers or plants which have been planted in the base 110, if desired additionally, the base 110 may be provided with wheels or a wheel assembly (not shown) which will aid in moving or transporting the fountain for a planter 100 from one location to another. An electrical cord 112 is also provided through an opening 114 in an exterior side 116 of the planter 102. Again, the cord is attached to a pump, such as the pump 40, for pumping water 106 from the interior 104 through the water discharge device 108.

FIG. 5 illustrates another preferred embodiment of this invention. In this embodiment, the planter 512 is similar to the planter 12 in that it has a hollow interior which is filled with water. Any of a range of discharge devices may be associated with the planter 512. A pump (not shown in FIG. 5) is associated with the discharge device. The pump may be battery-operated, if desired, or an electrical connection may be used as described above. In this embodiment, the external arrangement of additional planters include an upper portion 515, a lower portion 517, and a pair of side planters 519, 521, respectively. As illustrated, the planters 515, 517, 519 and 521 form a continuous arrangement around and about the planter 512. This construction provides a unique, three-dimensional arrangement of plants in a fountain structure not available in other arrangements with which I am familiar.

It should be further recognized that the fountain of the present invention can be constructed of various materials and can be assembled from separable components or formed as a unitary construction. Preferably, the fountain for a planter will be of relatively lightweight in order for it to be easily positioned, secured in place, removed, and transported elsewhere for use or storage. Additionally, although the shapes of the various planters have been shown to be generally circular in shape, it is also possible to use planters have other shapes, such as rectangular, triangular, or combinations thereof. An advantage of the fountain of the present invention may be constructed using off the shelf or commonly available components.

From all that has been said, it will be clear that there has thus been shown and described herein a fountain which fulfills the various objects and advantages sought therefor. It will become apparent to those skilled in the art, however, that many changes, modifications, variations, and other uses and applications of the subject fountain for a planter are possible and contemplated. All changes, modifications, variations, and other uses and applications which do not depart from the spirit and scope of the invention are deemed to be covered by the invention, which is limited only by the claims which follow.

What is claimed is:

1. A fountain comprising:
a planter having a hollow interior for storing a quantity of water;
a pump for pumping the quantity of water within the planter;
a water discharge device connected to the pump for discharging the quantity of water; and
a second planter positioned on an exterior surface of the planter.

2. The fountain of claim 1 further comprising a third planter positioned on the exterior surface of the planter, the third planter being at a location along the exterior surface different from the second planter.

3. The fountain of claim 2 wherein the third planter is positioned at a first height along the exterior surface and the second planter is positioned at a height different from the first height.

4. The fountain of claim 3 further including at least one side planter extending between the second and third planters.

5. The fountain of claim 1 wherein the planter has a bottom and the pump is positioned along the bottom.

6. The fountain of claim 1 wherein the water discharge device is a fountain head.

7. The fountain of claim 1 wherein the water discharge device is a sprinkler head.

8. The fountain of claim 1 wherein the water discharge device comprises a tubular post member and a fountain head, the post member for providing water from the pump to the fountain head.

9. A fountain comprising:
a planter having a hollow interior for storing a quantity of water;
a pump for pumping the quantity of water within the planter;
a water discharge device connected to the pump for discharging the quantity of water; and
a base adapted for having the planter positioned thereon, the base being wider than the planter and for receiving a portion of the quantity of water being discharged from the water discharge device.

10. The fountain of claim 8 wherein the base is adapted for holding plants or flowers to be watered.

11. The fountain of claim 8 wherein the planter has a bottom and the pump is positioned on the bottom.

12. The fountain of claim 8 wherein the water discharge device is a fountain head.

13. The fountain of claim 8 wherein the water discharge device is a sprinkler head.

14. The fountain of claim 8 wherein the water discharge device comprises a tubular post member and a fountain head, the post member for providing water from the pump to the fountain head.

15. The fountain of claim 8 wherein the base further comprises a wheel assembly for moving the base and the planter.

16. A fountain comprising:
a planter having an upper rim and an interior for storing a quantity of water;
a pump for pumping the quantity of water within the planter;
a water discharge device connected to the pump for discharging the quantity of water; and
a second planter positioned along the upper rim, the second planter being wider that the planter, the second planter for holding flowers or plants and for receiving a portion of the quantity of water being discharged from the water discharge device to water the flowers or plants.

17. The fountain of claim 15 wherein the planter has a bottom and the pump is positioned on the bottom.

18. The fountain of claim 15 wherein the water discharge device is a fountain head.

19. The fountain of claim 15 wherein the water discharge device is a sprinkler head.

20. The fountain of claim 15 wherein the water discharge device comprises a post member connected to the pump and a fountain head, the post member for providing water from the pump to the fountain head.

21. The fountain of claim 15 wherein the water discharge device comprises a post member having one end connected to the pump and another end connected to a pair of fountain heads, the post member for providing water from the pump to the fountain heads.

22. The combination, a fountain, comprising a first planter defining a water storage area; a pump positioned in the planter; a water discharge device connected to the pump for discharging a quantity of water; a second planter arranged with respect to the first planter including an upper portion, a lower portion and a side portion integrally formed with one another to provide a continuous planting area of various heights positioned about the first planter.
